(19) United States
(12) Patent Application Publication
(10) Pub. No.: US 2016/0075263 A1
(43) Pub. Date: Mar. 17, 2016

(54) Headrest Assembly

(71) Applicant: Majid Sabour, Los Angeles, CA (US)

(72) Inventor: Majid Sabour, Los Angeles, CA (US)

(21) Appl. No.: 14/489,170

(22) Filed: Sep. 17, 2014

(51) Int. Cl. B60N 2/48; A47G 9/10

(52) U.S. Cl. CPC B60N 2/4879; A47G 9/1027

(57) ABSTRACT

A headrest assembly for supporting a user's head while the user sleeps in a chair includes a chair structured to support a user. A pillow is provided. The pillow is structured to be coupled to the chair. The pillow may support the user's head while the user sits in the chair.

### BACKGROUND OF THE DISCLOSURE

### Field of the Disclosure

The disclosure relates to headrest devices and more particularly pertains to a new headrest device for supporting a user's head while the user sleeps in a chair.

### SUMMARY OF THE DISCLOSURE

An embodiment of the disclosure meets the needs presented above by generally comprising a chair structured to support a user. A pillow is provided. The pillow is structured to be coupled to the chair. The pillow may support the user's head while the user sits in the chair.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a headrest assembly according to an embodiment of the disclosure.

FIG. 2 is a left side view of an embodiment of the disclosure.

FIG. 3 is a back view of an embodiment of the disclosure.

FIG. 4 is an in-use view of an embodiment of the disclosure.

FIG. 5 is a perspective view of an alternative embodiment of the disclosure.

### DESCRIPTION OF THE PREFERRED EMBODIMENT

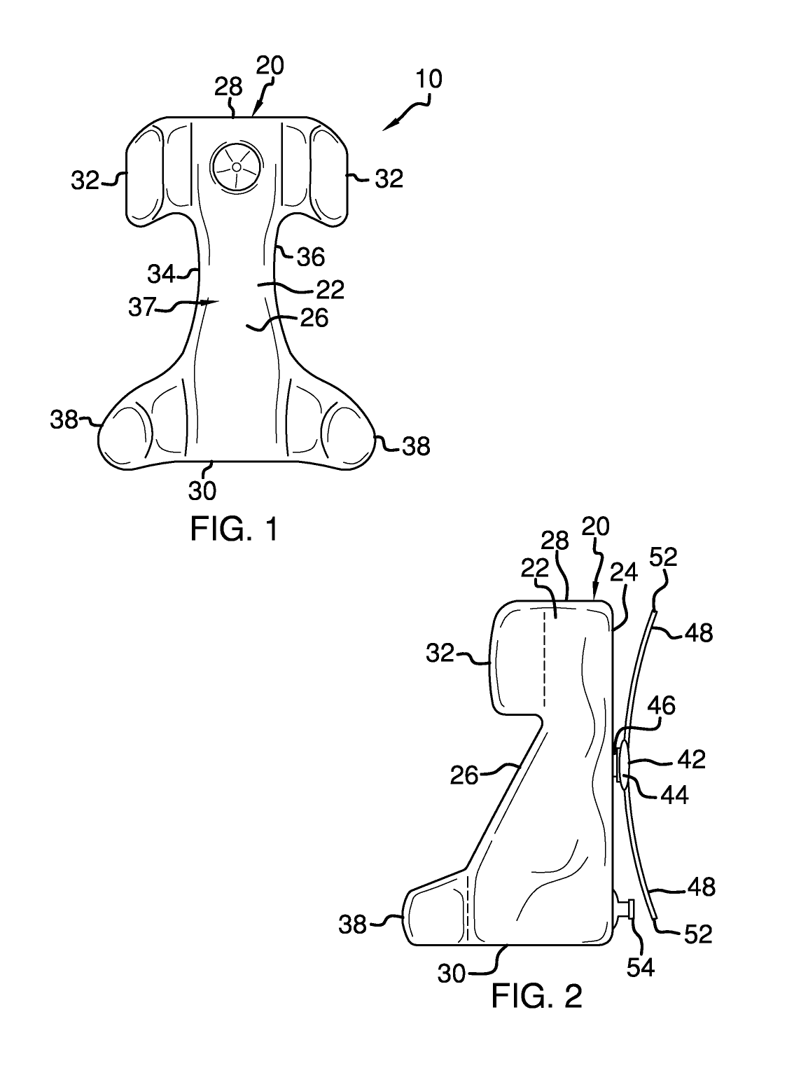

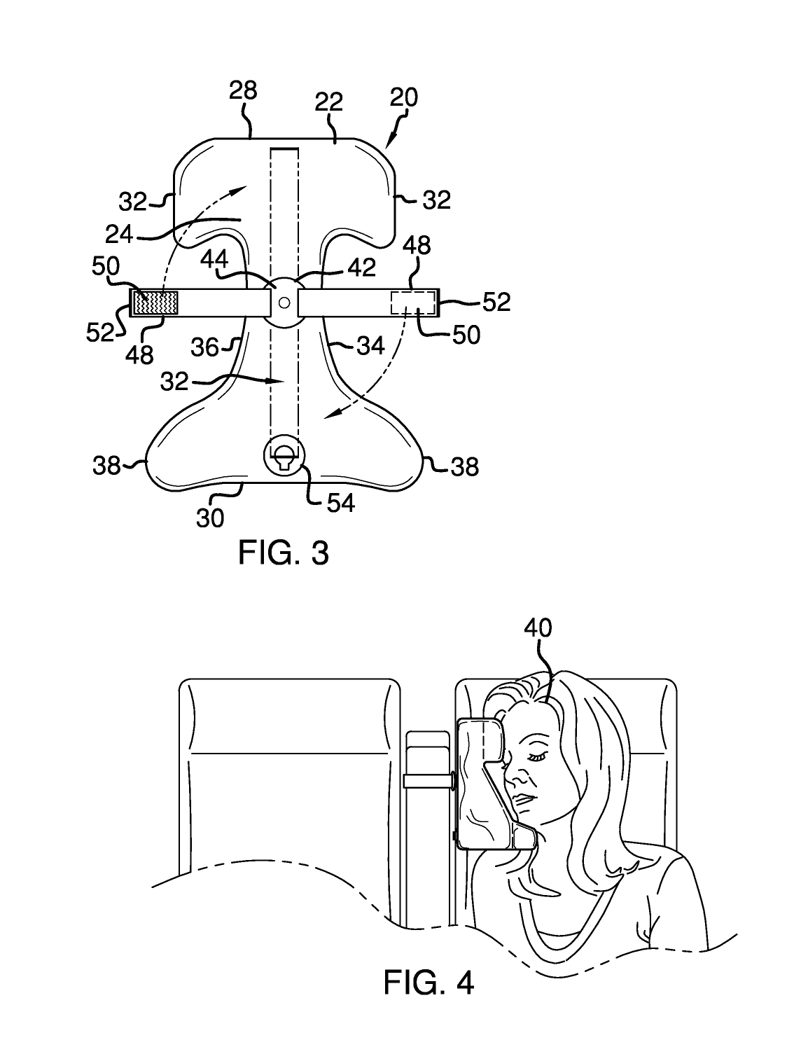

With reference now to the drawings, and in particular to FIGS. 1 through 5 thereof, a new headrest device embodying the principles and concepts of an embodiment of the disclosure and generally designated by the reference numeral 10 will be described.

As best illustrated in FIGS. 1 through 5, the headrest assembly 10 generally comprises a pillow 20. The pillow 20 has an outer wall 22. The outer wall 22 of the pillow has a back side 24 of the outer wall 22 of the pillow 20 coupled to a front side 26 of the outer wall 22 of the pillow 20. Moreover, the outer wall 22 of the pillow 20 forms a discrete interior of the pillow 20. The pillow 20 is elongated between a top end 28 and bottom end 30 of the pillow 20.

The pillow 20 may be coupled to a chair 12 structured to support a user 14. The chair 12 may be a chair in a vehicle 16. Additionally, the vehicle 16 may be an airplane, bus or other similar vehicle. The chair 12 may be further structured to have an arm rest 18 movably coupled to the chair 12.

The outer wall 22 of the pillow 20 defines a pair of upper lobes 32 each extending laterally away from an associated one of a first lateral side 34 and a second lateral side 36 of a central portion 37 of the pillow 20. The upper lobes 32 are each positioned proximate the top end 28 of the pillow 20. Additionally, the outer wall 22 of the pillow 20 defines a pair of lower lobes 38 each extending laterally away from an associated one of the first 34 and second 36 lateral sides of the central portion 37 of the pillow 20. The lower lobes 38 are each positioned proximate the bottom end 30 of the pillow 20.

The central portion 37 of the pillow 20 is curved between the first 34 and second 36 lateral sides of the central portion 37 of the pillow 20. The upper 32 and lower 38 lobes are directed forwardly from the central portion 37 of the pillow 20. Moreover, the pillow 20 has a U-shaped cross section taken perpendicular to a line extending through the top 28 and bottom 30 ends of the pillow 20. The pillow 20 may envelop the user's head 40 when the user 14 sits in the chair 12.

A coupler 42 is provided. The coupler 42 has a rotating portion 44 of the coupler 42 rotatably coupled to a fixed portion 46 of the coupler 42. The fixed portion 46 of the coupler 42 is coupled to the back side 24 of the outer wall 22 of the pillow 20. Additionally, the coupler 42 is centrally positioned on the back side 24 of the outer wall 22 of the pillow 20. The rotating portion 44 of the coupler 42 is spaced away from the back side 24 of the outer wall 22 of the pillow 20.

A pair of straps 48 is provided. Each of the pair of straps 48 is coupled to the rotating portion 44 of the coupler 42. The straps 48 each extend laterally away from the opposite sides of the rotating portion 44 of the coupler 42. A pair of fasteners 50 is each coupled to an associated one of the straps 48 proximate a free end 52 of each of the straps 48. The fasteners 50 are complementary so the straps 48 may be coupled together. The fasteners 50 may each be hook and loop fasteners.

A valve 54 is provided. The valve 54 is coupled to the back side 24 of the outer wall 22 of the pillow 20. The valve 54 is in fluid communication with the discrete interior of the pillow 20. The valve 54 allows air to be urged into the discrete interior of the pillow 20 to inflate the pillow 20.

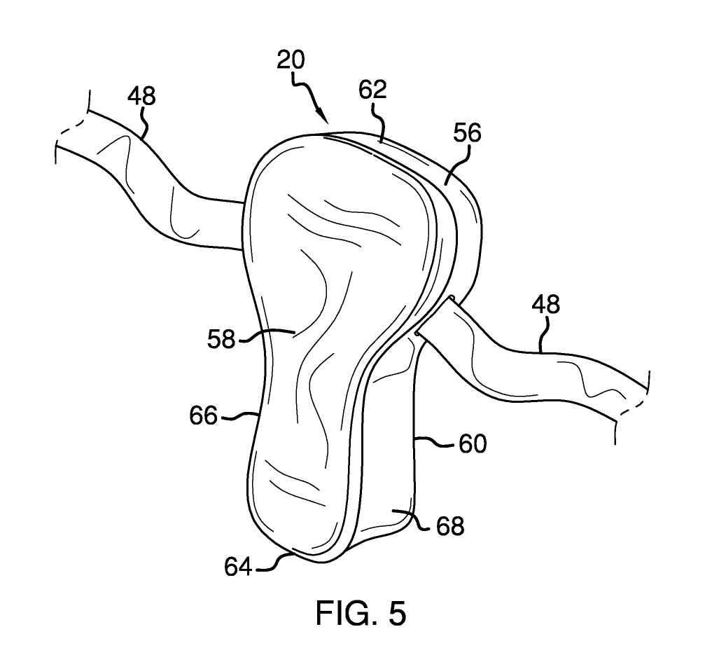

Alternatively as shown in FIG. 5, the pillow 20 may have an exterior edge 56 extending between each of a forward side 58 and rear side 60 of the pillow 20. The pillow 20 is elongated between an upper end 62 and a lower end 64 of the pillow 20. Additionally, the exterior edge 56 of the pillow 20 undulates between the upper 62 and lower 64 ends of the pillow 20 so the pillow 20 has a pear shape. The straps 48 are each coupled to an associate one of a first oblique side 66 and a second oblique side 68 of the exterior edge 56 of the pillow 20. The straps 48 are coupled to the chair 12 so the pillow 20 is positioned behind the user's head 40.

In use, the arm rest 18 on the chair 12 is positioned to extend upwardly along the chair 12. The straps 48 are wrapped around the arm rest 18. The fasteners 50 engage one another to retain the pillow 20 on the arm rest 18. The pillow 20 is rotated on the coupler 42 to position the pillow 20 in a selected orientation with respect to the user's head 40. The user 14 positions the user's head 40 in the pillow 20 so the upper lobes 32 abut the user's forehead 70 and the lower lobes 38 abuts the user's jaw 72. The assembly 10 allows the user 14 to sleep while sitting upright in the chair 12. Additionally, the assembly 10 prevents the user 14 from developing neck pain while sleeping upright in the chair 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A headrest assembly comprising:
a pillow;
a coupler, said coupler being coupled to a back side of an outer wall of said pillow, said coupler having a rotating portion wherein said rotating portion is rotatable relative to said pillow; and
a pair of straps, each of said strap being coupled to said rotating portion wherein each of said straps is coupled to said pillow and said straps are rotatable with said rotating portion of said coupler wherein said straps are structured to be coupled to a chair.

2. The assembly according to claim 1, further comprising said back side of said outer wall of said pillow coupled to a front side of said outer wall of said pillow such that said outer wall of said pillow forms a discrete interior of said pillow, said pillow being elongated between a top end and bottom end said pillow.

3. The assembly according to claim 2, further comprising said outer wall of said pillow defining a pair of upper lobes each extending laterally away from an associated one of a first lateral side and a second lateral side of a central portion of said pillow, said outer lobes each being positioned proximate said top end of said pillow.

4. The assembly according to claim 3, further comprising said outer wall of said pillow defining a pair of lower lobes each extending laterally away from an associated one of said first and second lateral sides of said central portion of said pillow, said lower lobes each being positioned proximate said bottom end of said pillow.

5. The assembly according to claim 4, further comprising said central portion of said pillow being curved having said upper and lower lobes being directed forwardly from said central portion of said pillow such that said pillow is configured to envelop the user's head.

6. (canceled)

7. (canceled)

8. The assembly according to claim 2, further comprising a valve coupled to said back side of said outer wall of said pillow such that said valve is in fluid communication with said discrete interior of said pillow.

9. The assembly according to claim 8, further comprising said valve allowing air to be urged into said discrete interior of said pillow such that said pillow is inflated.

10. A headrest assembly comprising:
a pillow, said pillow having an outer wall, said outer wall of said pillow having a back side of said outer wall of said pillow coupled to a front side of said outer wall of said pillow such that said outer wall of said pillow forms a discrete interior of said pillow, said pillow being elongated between a top end and bottom end said pillow, said pillow being configured to be coupled to a chair;
a coupler, said coupler being coupled to said back side of said outer wall of said pillow, said coupler having a rotating portion wherein said rotating portion is rotatable relative to said pillow;
said outer wall of said pillow defining a pair of upper lobes each extending laterally away from an associated one of a first lateral side and a second lateral side of a central portion of said pillow, said outer lobes each being positioned proximate said top end of said pillow;
said outer wall of said pillow defining a pair of lower lobes each extending laterally away from an associated one of said first and second lateral sides of said central portion of said pillow, said lower lobes each being positioned proximate said bottom end of said pillow;
said central portion of said pillow being curved having said upper and lower lobes being directed forwardly from said central portion of said pillow such that said pillow is configured to envelop the user's head when the user sits in said chair;
a pair of straps, each of said strap being coupled to said rotating portion wherein each of said straps is coupled to said pillow and said straps are rotatable with said rotating portion of said coupler wherein said straps are structured to be coupled to the chair; and
a valve coupled to said back side of said outer wall of said pillow such that said valve is in fluid communication with said discrete interior of said pillow, said valve allowing air to be urged into said discrete interior of said pillow such that said pillow is inflated.
